(19) United States
(12) Patent Application Publication
(10) Pub. No.: US 2023/0174796 A1
(43) Pub. Date: Jun. 8, 2023

(54) FOULANT RESISTANT SURFACES FOR PHASE CHANGE HEAT

(71) Applicants: Northwestern University, Evanston, IL (US); Argonne National Laboratory, Lemont, IL (US)

(72) Inventors: Harold H. Kung, Evanston, IL (US); Kyoo-Chul Kenneth Park, Evanston, IL (US); Jian Cao, Evanston, IL (US); Neelesh A. Patankar, Evanston, IL (US); Kornel F. Ehmann, Evanston, IL (US); Suman Bhandari, Evanston, IL (US); Christian John Machado, Evanston, IL (US); Zilin Jiang, Evanston, IL (US); Tom Yu Zhao, Evanston, IL (US); Meltem Urgun-Demirtas, Lemont, IL (US)

(21) Appl. No.: 18/061,048

(22) Filed: Dec. 2, 2022

Related U.S. Application Data
(60) Provisional application No. 63/285,204, filed on Dec. 2, 2021.

(51) Int. Cl. C09D 5/16; C09D 1/00

(52) U.S. Cl. CPC C09D 5/1618; C09D 5/1681; C09D 1/00

(57) ABSTRACT

A method of forming a metasurface includes forming a plurality of channels on a surface of a formed from a first material, like a metal, ceramic, or polymer. The method also includes filling the plurality of channels in the surface of the base substrate with a second material that is different from the first material to form a metasurface on the base substrate. The method further includes placing the metasurface into a heat exchange system such that the metasurface is proximate to a liquid used in the heat exchange system.

### CROSS-REFERENCE TO RELATED APPLICATION

The present application claims the priority benefit of U.S. Provisional Patent App. No. 63/285,204 filed on Dec. 2, 2021, the entire disclosure of which is incorporated by reference herein.

### STATEMENT REGARDING FEDERALLY SPONSORED RESEARCH

This invention was made with government support under grant number DE-AC02-06H11357 awarded by the Department of Energy. The government has certain rights in the invention.

### BACKGROUND

Various machines and instruments operate using the principles of phase changes, heat dissipation, cooling, etc. of a substance to cause an effect. As an example, a heat exchanger is a system that can be used for both heating and cooling applications, including space heaters, air conditioning systems, power plant cooling systems, sewage treatment systems, etc. In operation, many of these systems utilize a circulating fluid to collect heat (or cold), and air or another gas is used to help transport the heat (or cold) to either an area to be climate controlled or the ambient environment.

### SUMMARY

An illustrative method of forming a metasurface includes forming a plurality of channels on a surface of a metallic sheet formed from a first metal. The method also includes filling the plurality of channels in the surface of the metallic sheet with a second metal (or other material with differing surface chemistry than the base material) that is different from the first metal to form a metasurface on the metallic sheet. The method further includes placing the metallic sheet into a heat exchange system such that the metasurface is proximate to the phase change material used in the heat exchange system.

In one embodiment, the plurality of channels form a cross-grid pattern on the surface of the metallic sheet. In another embodiment, the plurality of channels can exist entirely in one direction. In a specific embodiment, the first metal comprises steel and the second metal comprises copper. In one embodiment, filling the plurality of channels comprises electroplating the second metal onto the surface of the metallic sheet. In an illustrative embodiment, the metasurface is designed to passively resist foulant accumulation as compared to a single material surface.

One embodiment includes forming a plurality of regions in the metasurface, where each region has different channel characteristics or a different channel pattern. For example, the method can include forming a first region of the metasurface with a channel pattern of parallel lines, and forming a second region of the metasurface with a cross-grid or a parallel channel pattern. The method can also include forming a first region with channels having a first depth, and forming additional regions with channels having depths that differ from the first depth. The method can also include forming a first region with channels having a first width, and forming additional regions with channels having widths that differ from the first width. The method can also include forming a first region with channels having a first pitch, and forming additional regions with channels having pitches that differ from the first pitch. The method can further include forming a first region with channels having a first cross-sectional profile, and forming a second region with channels having a second cross-sectional profile that differs from the first cross-sectional profile.

In other embodiments, the method includes determining, based on the type of application and extent of phase change that occurs instantaneously and over time, one or more characteristics of the plurality of channels formed on the surface of the metallic sheet. In another embodiment, the method includes determining, based on the type of application and extent of phase change that occurs instantaneously and over time, a pattern of the plurality of channels formed on the surface of the metallic sheet.

An illustrative metasurface for use in a heat exchange system includes a substrate in the form of a metallic sheet that is formed from a first metal, and a plurality of channels formed on a surface of the substrate. The metasurface also includes a second material that is different from the first metal (in this case a metal), where the second material is within the channels formed in the substrate such that the metasurface passively resists foulant aggregation as compared to a single material surface.

In one embodiment, the plurality of channels is formed as a cross-grid pattern on the surface of the metallic sheet. In another embodiment, the first metal comprises steel and the second metal comprises copper. In another embodiment, the substrate is segmented into a plurality of regions, and each region has different channel characteristics or a different channel pattern. In one embodiment, a first region of the metasurface has a channel pattern of parallel lines, and a second region of the metasurface has a cross-grid channel pattern. In another embodiment, a first region of the metasurface includes channels having a first depth, and a second region of the metasurface includes channels having a second depth that differs from the first depth. In yet another embodiment, a first region of the metasurface has channels of a first width, and a second region of the metasurface has channels of a second width that differs from the first width.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1A depicts example texture dimensions for a metasurface in accordance with an illustrative embodiment.

FIG. 1B depicts a stainless steel substrate in accordance with an illustrative embodiment.

FIG. 1C depicts three channels formed in the substrate in accordance with an illustrative embodiment.

FIG. 1D depicts copper placed in the channels formed in the substrate in accordance with an illustrative embodiment.

FIG. 2A depicts a copper electroplating process that can be used to form a metasurface in accordance with an illustrative embodiment.

FIG. 2B depicts an illustrative metasurface having pitch of 100 micrometers and 270 micrometers in accordance with an illustrative embodiment.

FIG. 2C depicts surface energies for a metasurface in accordance with an illustrative embodiment.

FIG. 3A depicts selective fouling in various regions of a surface in accordance with an illustrative embodiment.

FIG. 3B depicts position vs. height for a cross-section of a metasurface, demonstrating the topological effects of the selective deposition of foulant in accordance with an illustrative embodiment.

FIG. 4 depicts temperature vs time for an average standard deviation and an average upper temperature of the polished stainless steel surface in accordance with an illustrative embodiment.

FIG. 5 depicts qualitative fouling over time of a polished stainless steel surface in a heat exchange system in accordance with an illustrative embodiment.

FIG. 6 depicts qualitative fouling of an untextured copper surface over time in a heat exchange system in accordance with an illustrative embodiment.

FIG. 7 depicts an average of the two trials of fouling data for a region with 270 micron pitch, 90 micron wide channels, and channel depth ˜10 micron (heretofore abbreviated P270C090) of the metasurface in accordance with an illustrative embodiment.

FIG. 8 depicts qualitative fouling over time in P270C090 of the metasurface in accordance with an illustrative embodiment.

FIG. 9 depicts an average of the two trials of fouling data for a region with 100 micron pitch, 34 micron wide channels, and channel depth ˜10 micron (heretofore abbreviated P100C034) of the metasurface in accordance with an illustrative embodiment.

FIG. 10 depicts qualitative fouling over time in P100C034 of the metasurface in accordance with an illustrative embodiment.

FIG. 11A depicts the deposition patterns of foulant accumulating on a uniform, single-material surface during boiling.

FIG. 11B depicts the removal of foulant on a hybrid textured surface (P270C090) in the form of a flake, exposing the textured surface underneath

FIG. 12A depicts the average foulant surface coverage of the polished stainless steel surface in accordance with an illustrative embodiment.

FIG. 12B depicts foulant surface coverage of P270C090 of the metasurface in accordance with an illustrative embodiment.

FIG. 12C depicts foulant surface coverage of P100C034 of the metasurface in accordance with an illustrative embodiment.

FIG. 13A is a graph of area normalized mass gain of foulant on each of the steel and copper regions for the metasurface of FIG. 2 in accordance with an illustrative embodiment.

FIG. 13B depicts the effects of selective fouling on metasurfaces with increasing pitch in accordance with an illustrative embodiment.

FIG. 14A depicts the differences in anti-fouling behavior (i.e., flaking) on metasurfaces with differing pitch in accordance with an illustrative embodiment.

FIG. 14B shows flake patterns for different metasurfaces in accordance with an illustrative embodiment.

FIG. 14C is a graph that shows probability vs size for flake formation with metasurfaces of varying pitch in accordance with an illustrative embodiment.

FIG. 15A depicts the formation of fragile foulant structures caused by the various channel characteristics and configurations in accordance with an illustrative embodiment.

FIG. 15B depicts vapor bubble infiltration of a metasurface in accordance with an illustrative embodiment, illustrating that the flake removal could be generated by the shearing of bubble nucleates during phase change processes.

FIG. 15C is a three-dimensional graph that shows foulant surface coverage vs pitch vs channel width in accordance with an illustrative embodiment, indicating the effects of surface texture on the ability to generate optimal flaking.

FIG. 16 is a flow diagram that depicts operations performed to form a metasurface in accordance with an illustrative embodiment.

### DETAILED DESCRIPTION

Boilers and similar types of heat exchangers that utilize phase change to operate can experience a degradation in performance caused by the unintended and unwanted deposition of foulant. This foulant deposition reduces the overall heat transfer coefficient since these materials are highly insulating. Therefore, it is of critical importance to produce surfaces that passively resist foulant aggregation. As discussed herein, the inventors have demonstrated that a hybrid metasurface of both chemical affinity and thermal conductivity/expansion produced on the sub-millimeter scale can promote foulant self-removal that refreshes the bare surface and promotes high heat transfer. These surfaces can be used in heat exchanging operations to minimize operating costs, increase the time between cleaning cycles, and reduce the need for pre-treating the working fluid being used in the system, which may be water, hydrocarbons (e.g., methane, ethane, propane, butane, etc.), fluorocarbons (fluoride, polyvinylidene, etc.), etc.

Described herein is a surface design with a hybrid surface pattern and material on the sub-millimeter scale that induces passive self-removal of foulant caused by phase change heat transfer. More specifically, described herein is a hybrid metasurface that is constructed with microdomains composed of different materials (e.g., comprised of metals, ceramics, carbon, and/or polymers) such that it is more resistant to foulant deposition than an unstructured surface in phase change heat exchange applications. These microdomains can be in the form of unidirectional channels, square or rectangular grids, or other regular or irregular shapes, and arranged in regular or random patterns. The microdomains can also be of the dimension of one or more micrometers to several millimeters in some embodiments.

In one embodiment, the microdomains can be produced by micro-machining, laser ablation, rolling, stamping, three-dimensional (3D) printing, molding, electroplating, etching, or any other method known to produce patterned surfaces. For example, microdomains of copper in a rectangular grid pattern on a stainless steel surface can be produced by laser ablation of the flat stainless steel surface to produce a cross-grid pattern of channels. These channels are then filled with copper by electroplating or another process to completely fill the channels such that the resulting entire surface is topologically smooth. In an illustrative embodiment, the different domains of the structured surface differ in thermal conductivity and expansion, surface energy, and/or solid-solid adhesion between the foulant and surface. The differences in thermal conductivity between the materials helps to control boiling behavior by controlling the degree of surface superheat (i.e., the more conductive surface will have a larger superheat, promoting greater boiling on those regions). To induce the most selective fouling, the thermal conductivity difference should be made as large as practically possible. In a similar way, the differences in thermal expansion between the materials should be made as large as practically possible, to induce surface stresses that can assist in foulant removal. The differences in surface energy are primarily used to generate selective fouling (the first step towards generating anti-fouling behavior). The magnitude of the surface energy difference should be selected based on the geometry of the texture and the surface boiling behavior (based on the texture's local thermal conductivity differences) accordingly to induce the most selective foulant deposition. The solid-solid adhesion should be minimized as much as practically possible, as that assists in flake removal. The adhesion can be tuned by the materials selection (which should be done in coordination with all other variables) and/or the surface roughness (where smoother surfaces will generally reduce solid-solid adhesion).

It is noted that the metasurface does not have to be a thin sheet metal. The metasurface substrate can be in any thickness, and the manufacturing methods can include 3D printing. The surface materials can include other metallic, polymeric, and ceramic materials and their composites. Additionally, the channels that are filled with a second material may contain different depth, width, and shapes (other than straight lines).

In an illustrative embodiment, these hybrid metasurfaces are designed to be placed in direct contact with a working fluid (e.g., water, hydrocarbons, fluorocarbons, etc.) in a phase change heat exchanger. Because of their different properties, the rates of both boiling and foulant deposition are different on the different domains of the hybrid metasurface. After a critical foulant thickness is achieved, self-removal of the foulant on the surface is observed in the form of flakes that are then spontaneously removed either through gravity or the flow of liquid over it. Existing flow initiated by pumps can induce the stresses needed for flaking behavior, as do the natural flows occurring in boiling due to thermal gradients between the bulk and surface-heated fluids. Further, the formation and dissipation of bubbles can promote stresses to generate these foulant fractures. This passive self-cleaning effect helps maintain contact between the working fluid and the cleaned surface, which, in turn, promotes a lesser degree of heat transfer reduction by decreasing the accumulation of a thermally insulating foulant layer.

The proposed hybrid metasurfaces aim to reduce foulant aggregation on liquid-side heat exchanger boilers, immersion cooling systems, and other heat transfer systems like automobile radiators, electric vehicle battery thermal control systems, server farms' thermal management, and rocket propulsion. The aggregation of foulant on the surfaces of such systems produces a highly insulating layer that reduces overall heat transfer and increases operating costs. Because this problem results in such an extreme degradation of operating efficiency, process engineers must schedule heat exchanger down time to remove foulant. This down time adds extra costs since the overall capacity of the system is reduced. In addition, in traditional systems, significant time and cost is focused on pretreating the working fluid (i.e., water, hydrocarbons, fluorocarbons, etc.) before it enters the heat exchanger to reduce the concentration of potential foulants like calcium and magnesium carbonates, among others. This process includes expensive, tortuous membranes, and chemical flocculation, both serving to increase periodic costs. By creating surfaces that reduce foulant aggregation as discussed herein, a high overall heat transfer coefficient can be maintained for a longer period of time, reducing the need for frequent cleaning and liquid pretreatment, and thus, reducing costs.

The engineered hybrid metasurfaces described herein include microdomains of different patterns of different materials. These metasurfaces provide several distinct advantages over traditional systems. Notably, the proposed surfaces are low aspect ratio structures with substantial durability due to the materials they can be made from. These surfaces also promote foulant flaking and removal via the formation of fragile foulant structures caused by non-uniform, controllable foulant deposition (an intrinsic trait of the surface energy difference between materials), which is not seen in existing systems, providing a significant enhancement to long-term heat transfer, the result of which is increased efficiency and the associated cost savings. In existing systems, foulant accumulates in a random and generally uniform pattern, resulting in highly adhered and stable foulant layers that are largely robust to passive removal. The raw material cost can also be quite low because cost effective materials can be chosen for their chemical and thermal properties, where the dichotomy of surface properties is generally maximized. For example, a steel base surface can be combined with copper channels or polyethylene channels (both of which have thermal conductivity differences of ˜100 s W/m·K and surface energy differences greater than 1 mN/m²). Additionally, manufacturing can be realistically scaled up to produce large surface areas of these textured materials (e.g., via rolling, additive manufacturing, machining, and/or laser ablation, among other similar processes).

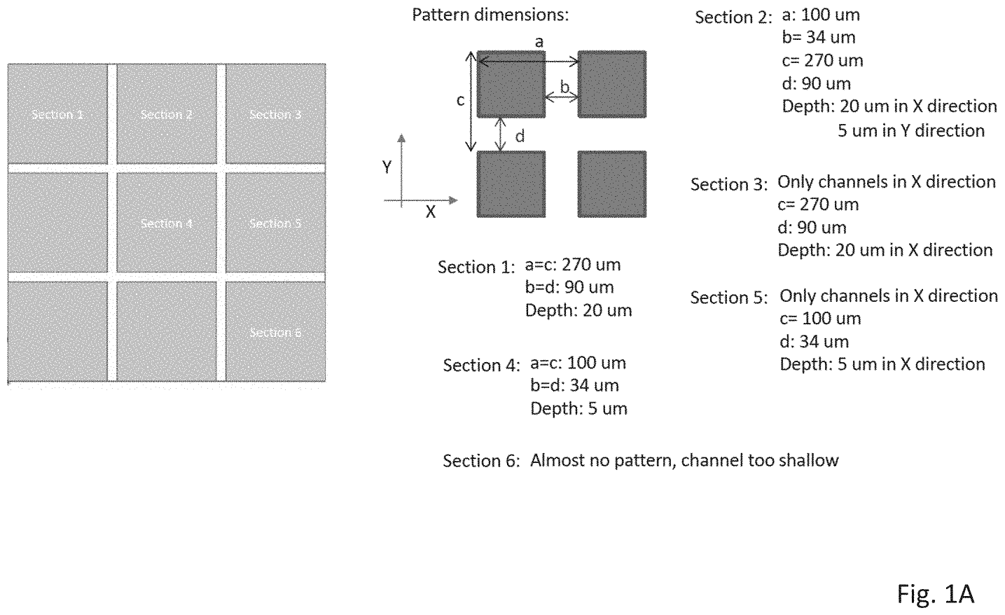

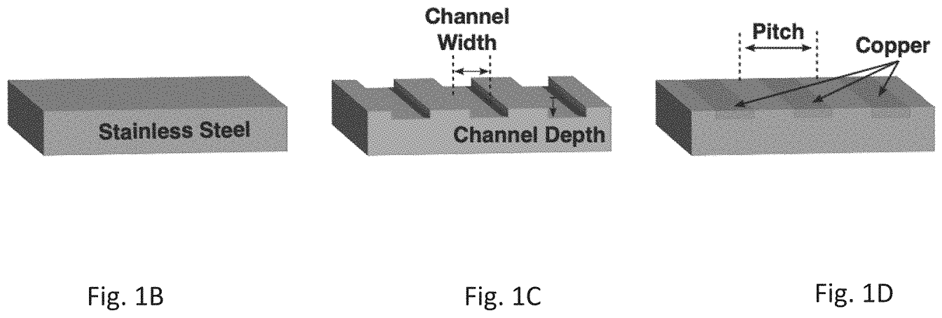

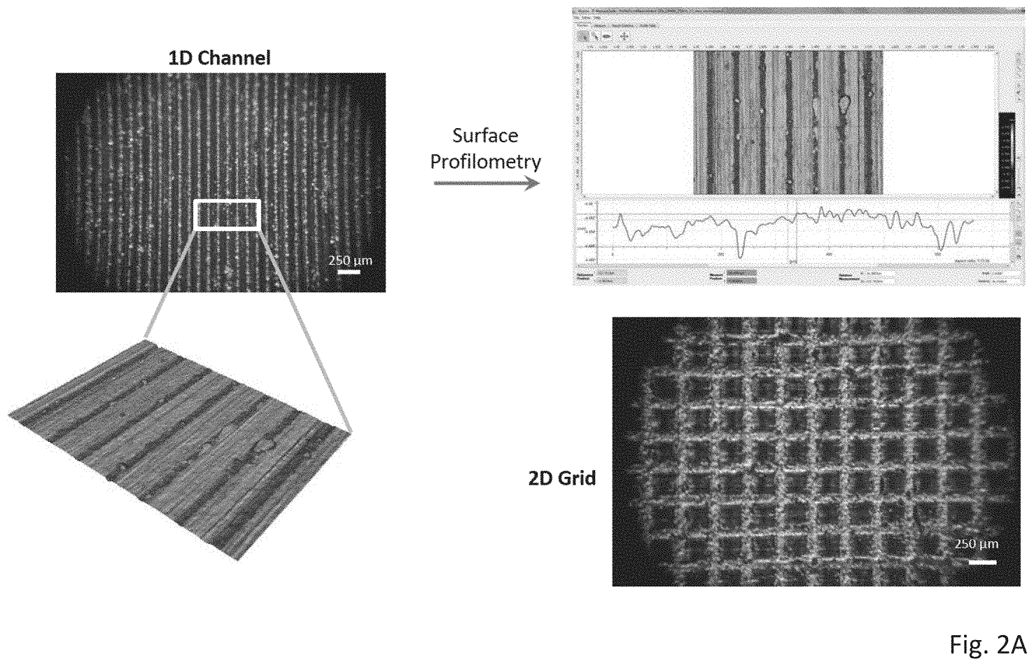

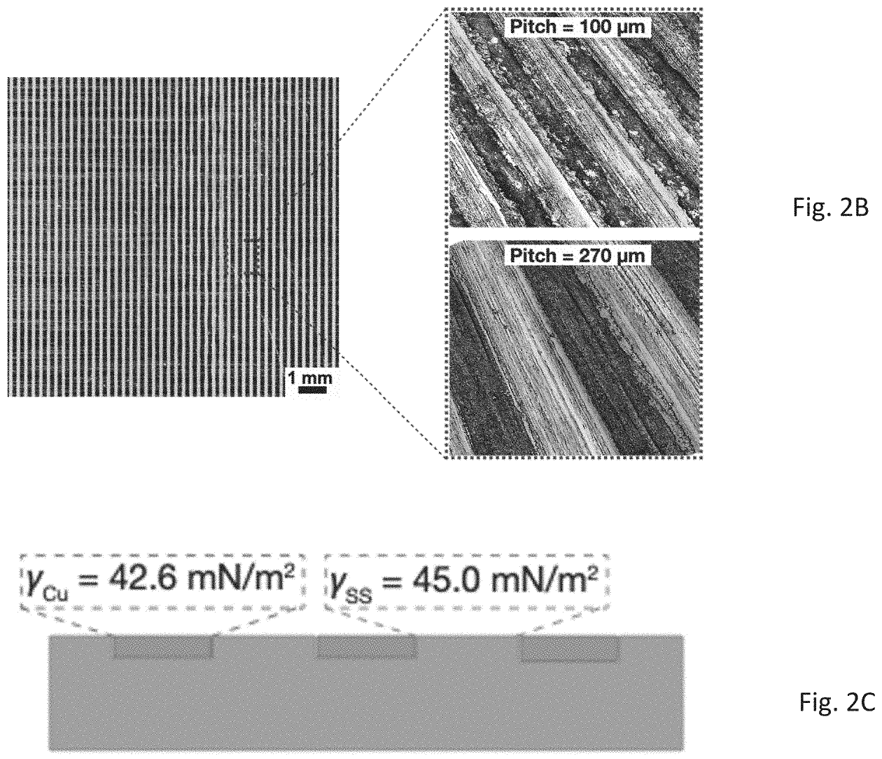

FIG. 1A defines the relevant design parameters and depicts example texture dimensions for a metasurface in accordance with an illustrative embodiment. As shown, the metasurface of FIG. 1A includes a number of different sections, each of which is controlled to have different dimensions and patterns. In alternative embodiments, a different number of sections, different patterns, and/or different dimensions may be used. FIG. 2A depicts a fabricated hybrid metasurface after a copper electroplating process is used in accordance with an illustrative embodiment. As shown in the left portion of FIG. 2A, the metasurface includes one-dimensional channels that can be effectively electroplated with copper across a number of different dimensions. The right portion of FIG. 2A depicts a surface profilometry for the one-dimensional channels showing they are filled with a secondary material, along with another embodiment that includes a two-dimensional grid of electroplated channels to form the surface.

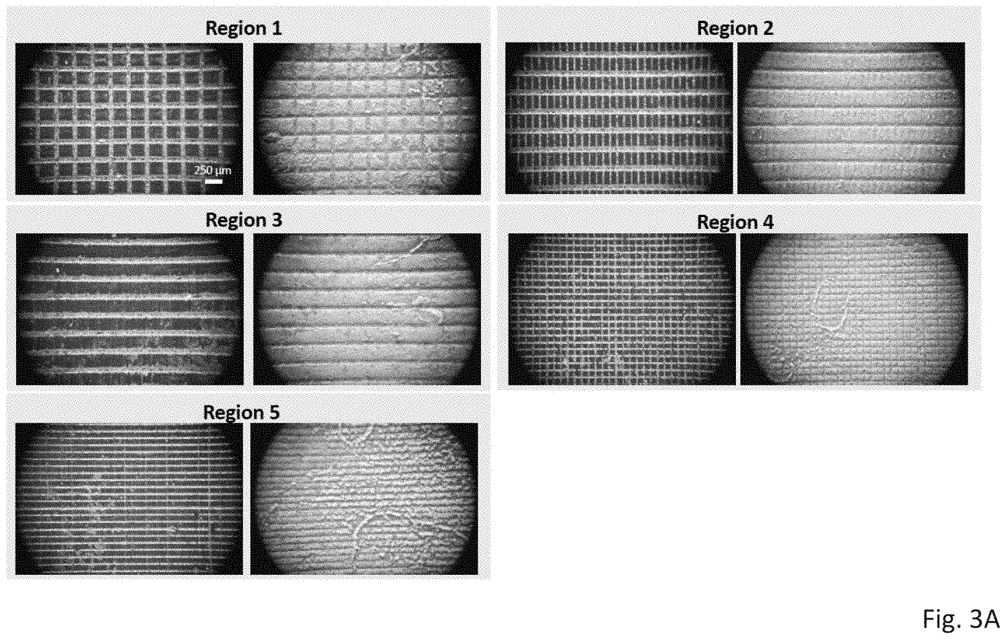

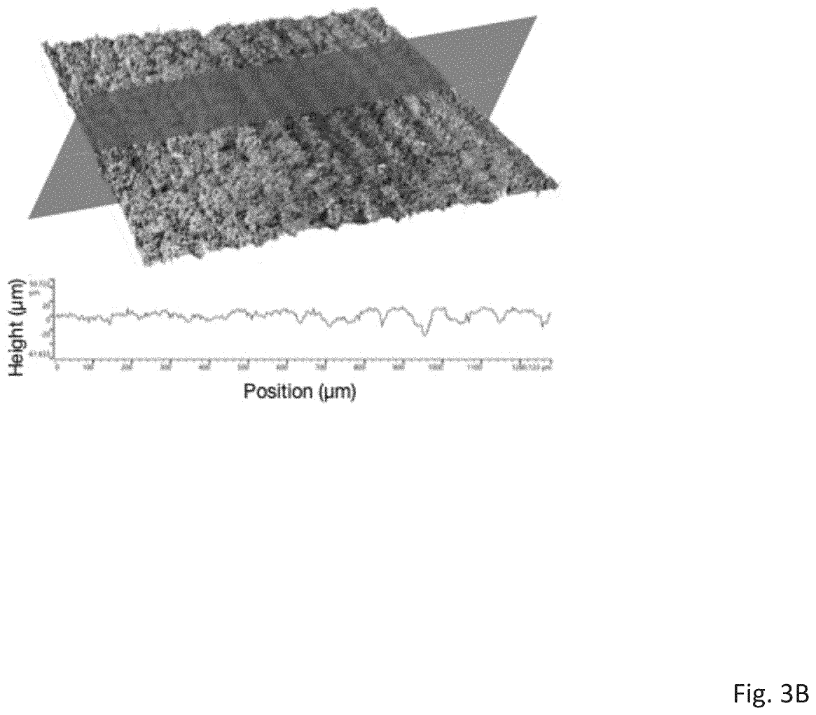

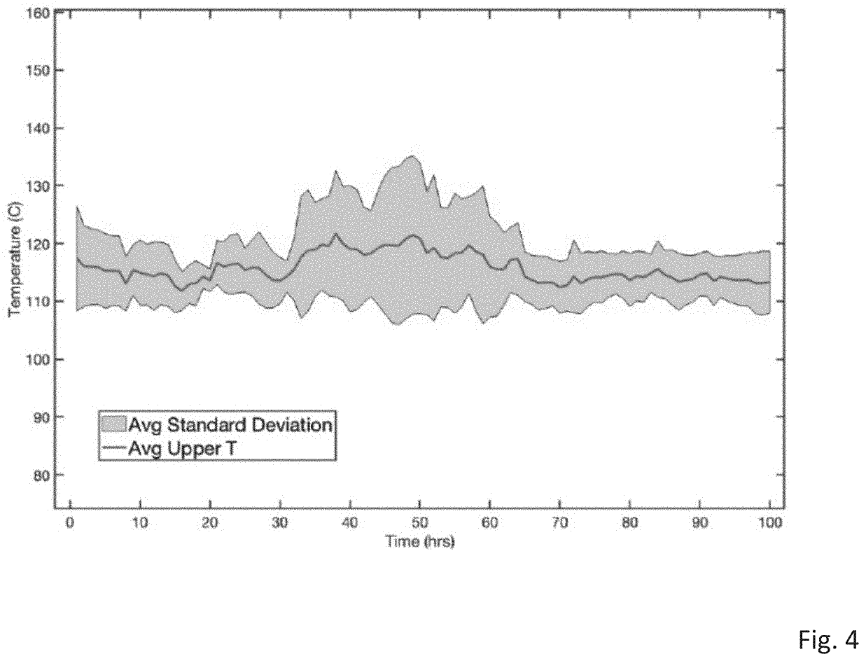

FIG. 3A depicts selective fouling in various regions of a surface in accordance with an illustrative embodiment. The metasurface of FIG. 3 includes 5 different regions, each of which has a different pattern and/or dimension(s) of electroplated (or otherwise filled) channels, each showing selective fouling. Surface profilometry also confirms the effects of selective fouling by showing the height increase for particular regions (leading to periodic height depressions where the channels exist). FIG. 3B depicts position vs. height for a cross-section of a metasurface, demonstrating the topological effects of the selective deposition of foulant in accordance with an illustrative embodiment. FIG. 4 depicts thermal data from a polished stainless steel surface used in a heat exchanging system. Specifically, FIG. 4 depicts temperature vs time for an average standard deviation and an average upper temperature of the polished stainless steel surface in accordance with an illustrative embodiment.

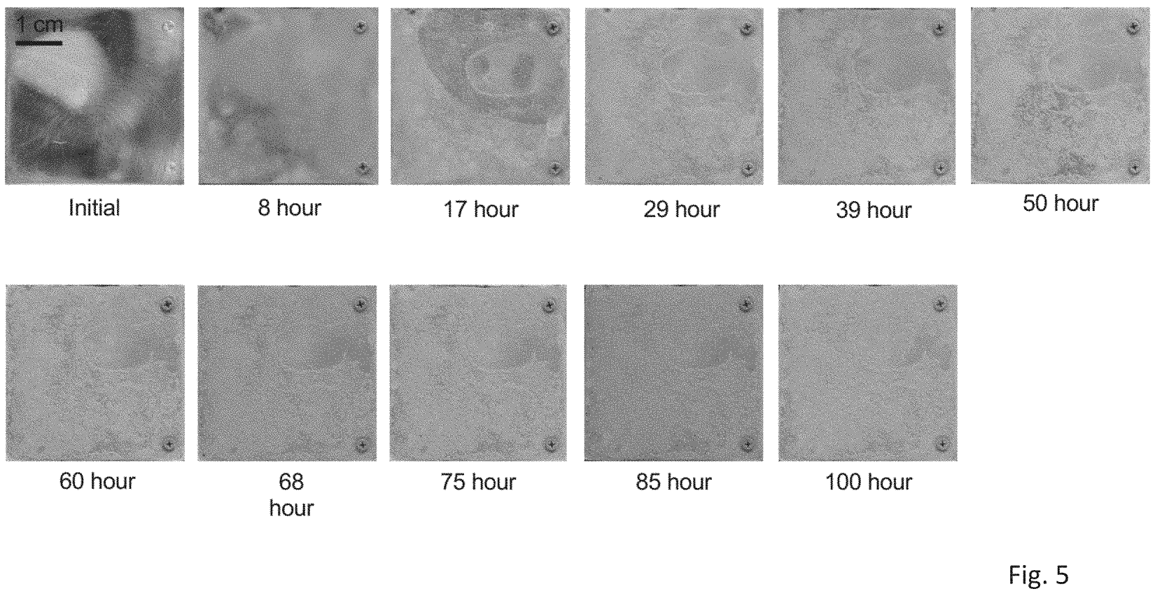

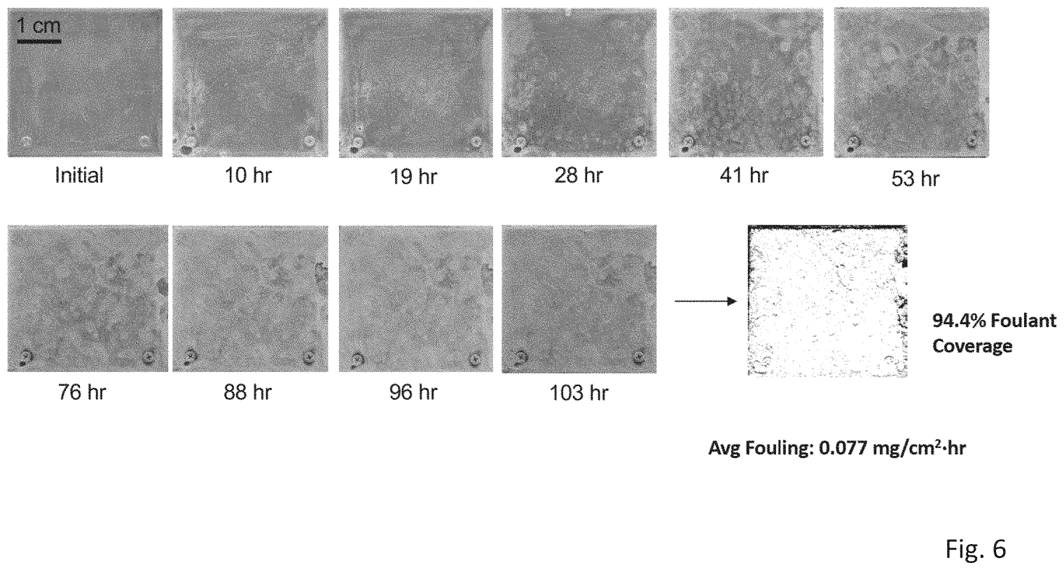

FIG. 5 depicts qualitative fouling over time of a polished stainless steel surface in a heat exchange system in accordance with an illustrative embodiment. The time period depicted is 100 hours, and images of the polished stainless steel surface are shown initially, at 8 hours, at 17 hours, at 29 hours, at 39 hours, at 50 hours, at 60 hours, at 68 hours, at 75 hours, at 85 hours, and at 100 hours. FIG. 6 depicts qualitative fouling of an untextured copper surface over time in a heat exchange system in accordance with an illustrative embodiment. The time period depicted is 103 hours, and images of the untextured copper surface are shown initially, at 10 hours, at 19 hours, at 28 hours, at 41 hours, at 53 hours, at 76 hours, at 88 hours, at 96 hours, and at 103 hours. The untextured copper surface had 94.4% foulant coverage after 103 hours, with an average fouling of 0.077 mg/cm²⁻hr.

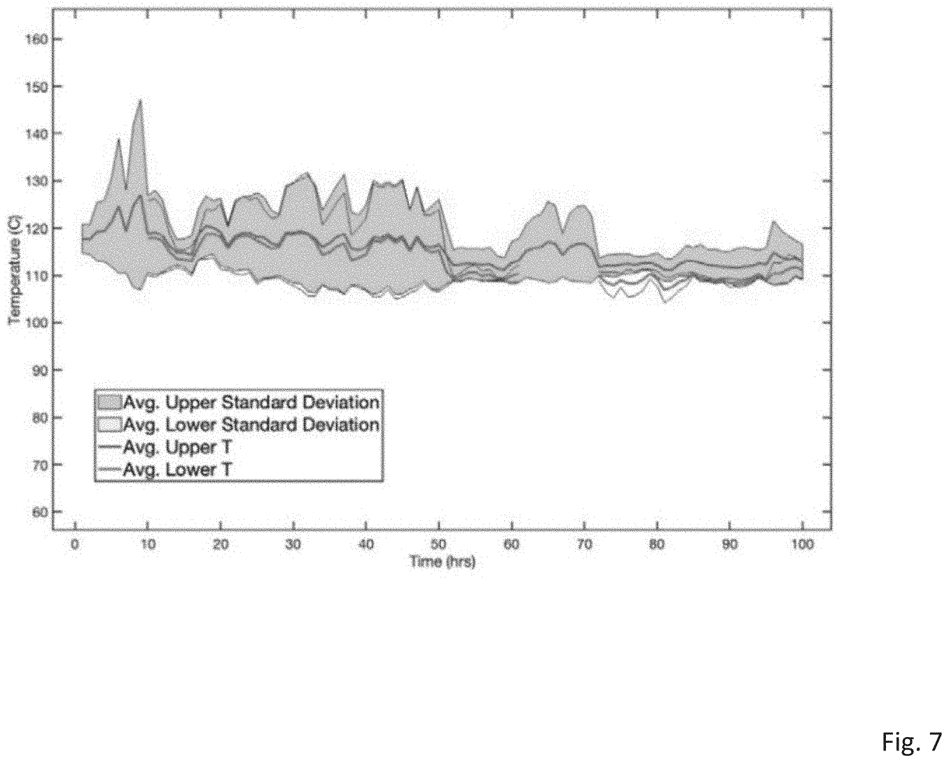

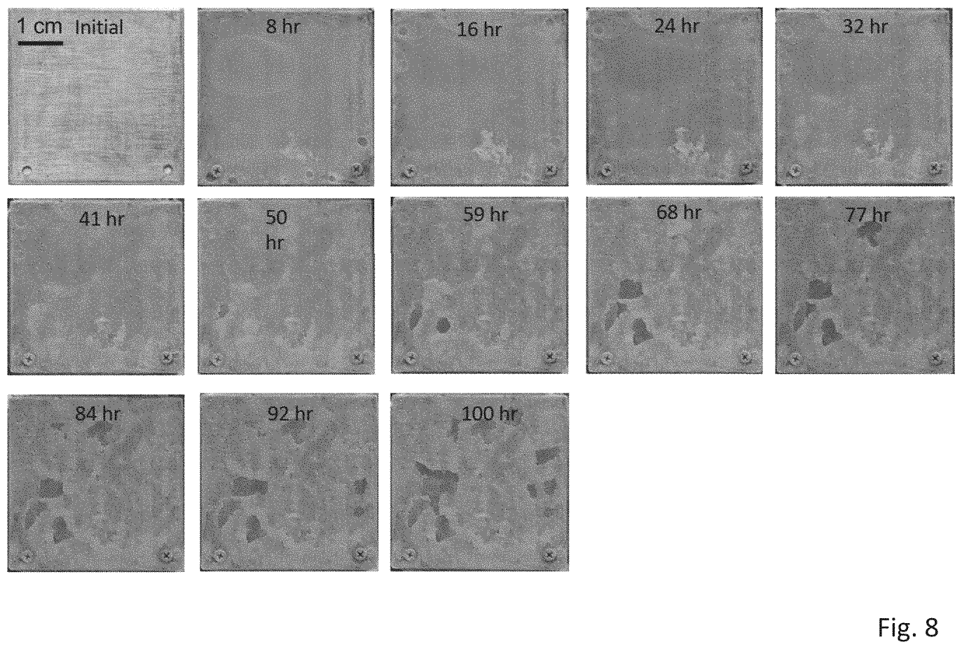

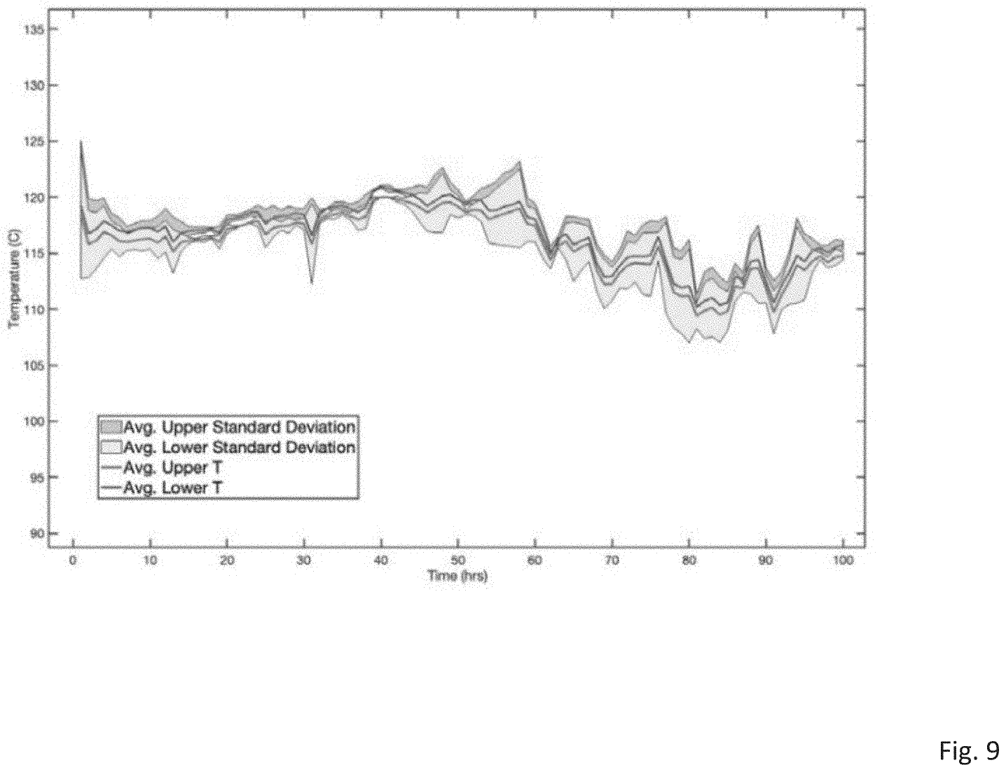

FIG. 7 depicts an average of the two trials of thermal data for the P270C090 of the metasurface in accordance with an illustrative embodiment. FIG. 8 depicts qualitative fouling over time for the P270C090 texture of the metasurface in accordance with an illustrative embodiment. The time period depicted is 100 hours, and images of P270C090 are shown initially, at 8 hours, at 16 hours, at 24 hours, at 32 hours, at 41 hours, at 50 hours, at 59 hours, at 68 hours, at 77 hours, at 84 hours, at 92 hours, and at 100 hours. FIG. 9 depicts an average of the two trials of thermal data for P100C034 of the metasurface in accordance with an illustrative embodiment.

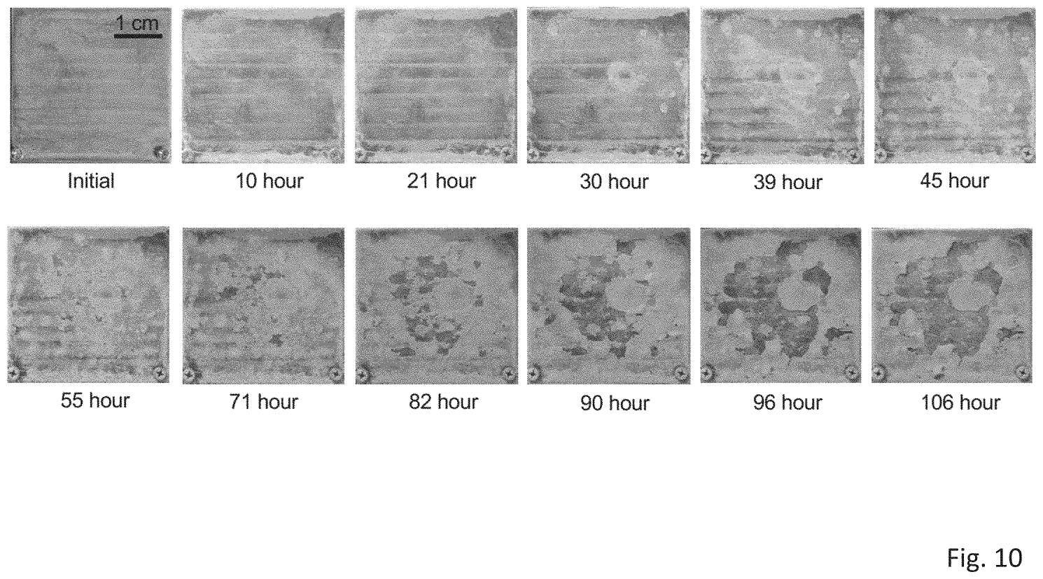

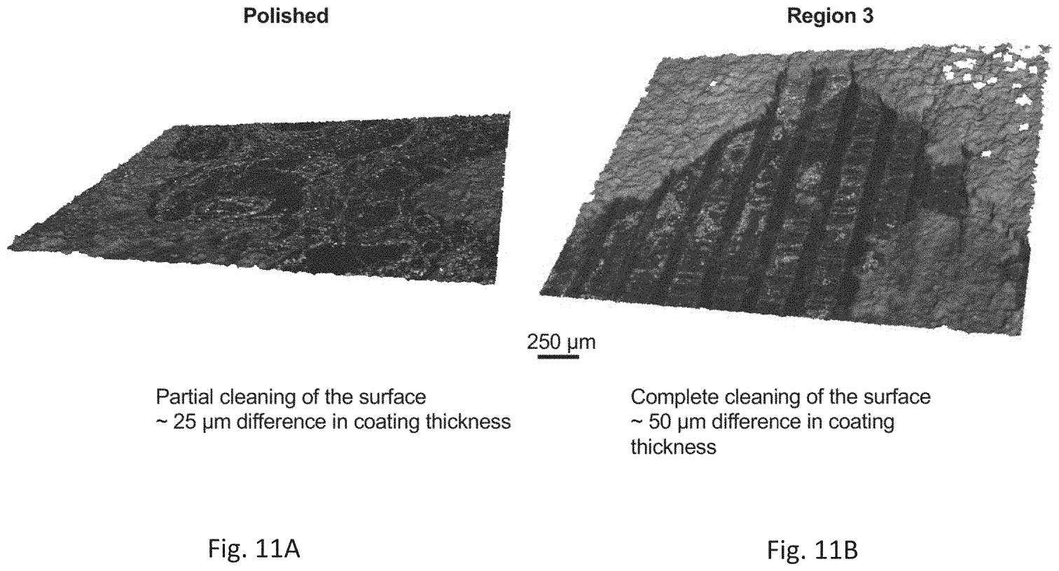

FIG. 10 depicts qualitative fouling over time in P100C034 of the metasurface in accordance with an illustrative embodiment. The depicted time period is 106 hours, and images of P100C034 are shown initially, at 10 hours, at 21 hours, at 30 hours, at 39 hours, at 45 hours, at 55 hours, at 71 hours, at 82 hours, at 90 hours, at 96 hours, and at 106 hours. FIG. 11A depicts the foulant deposition patterns for a polished surface, showing no clean surface regions that would indicate flaking, in accordance with an illustrative embodiment. FIG. 11B depicts foulant flaking activity for P270C090 of the metasurface, as evidenced by a clean surface feature, in accordance with an illustrative embodiment. In FIGS. 11A and 11B, foulant layer thicknesses were determined using a surface profilometer.

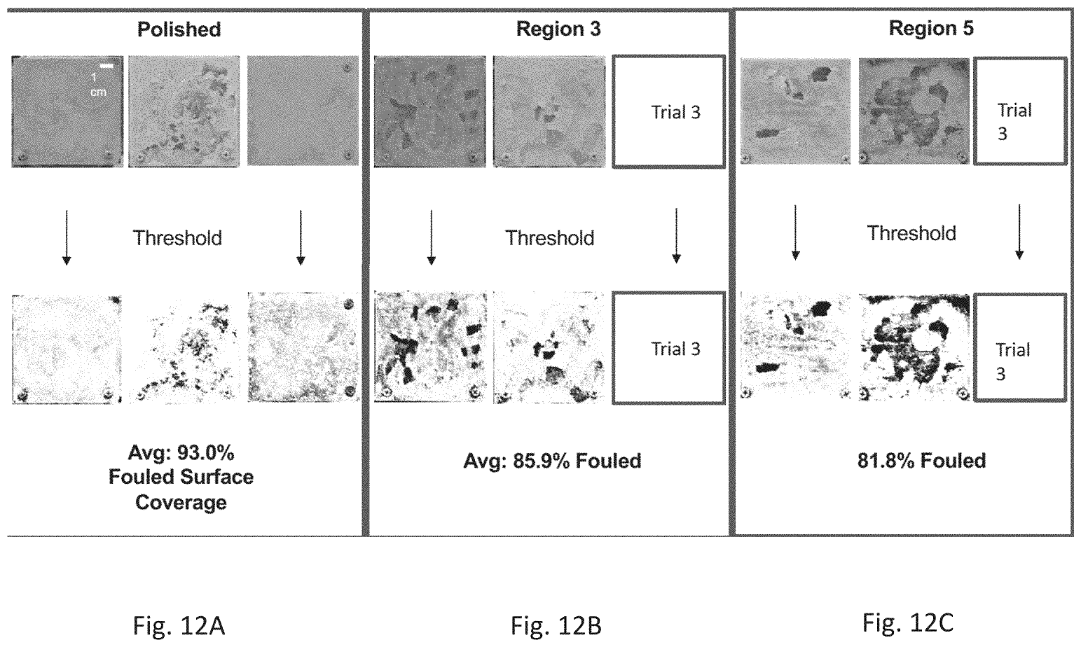

FIG. 12A depicts foulant surface coverage of the polished stainless steel surface in accordance with an illustrative embodiment. FIG. 12B depicts foulant surface coverage of P270C090 of the metasurface in accordance with an illustrative embodiment. FIG. 12C depicts foulant surface coverage of P100C034 of the metasurface in accordance with an illustrative embodiment. As shown, upon use in a heat exchanging system, the polished stainless steel surface has 93% fouled surface coverage, P270C090 of the metasurface had 85.9% fouled surface coverage, and the P100C034 of the metasurface had 81.8% fouled surface coverage.

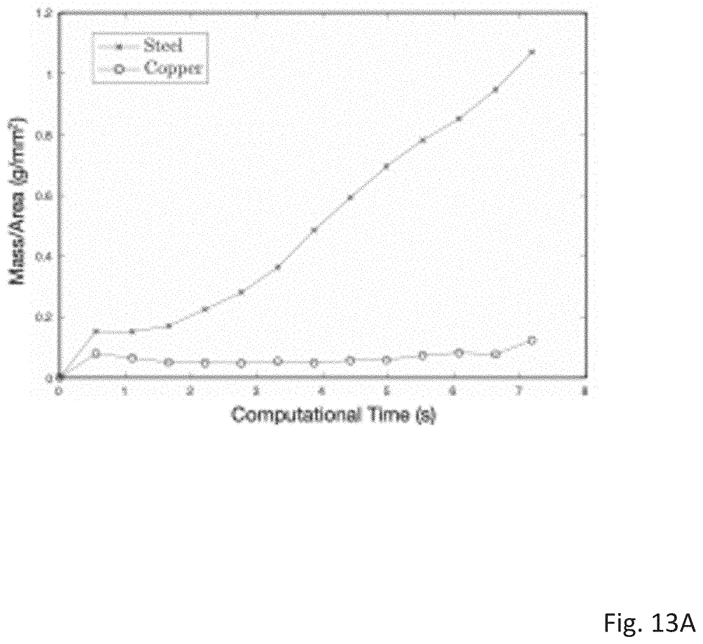

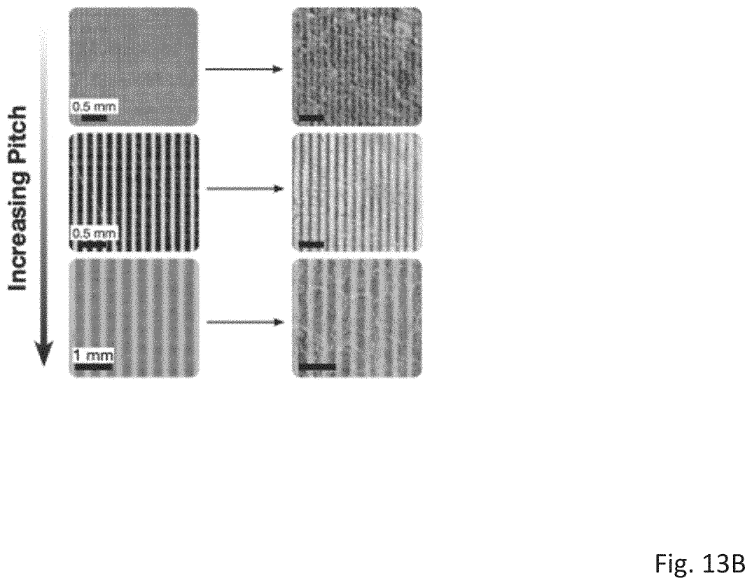

FIG. 13A is a graph of mass/area vs computational time for the metasurface of FIG. 3, showing the selective deposition of foulant is also predicted computationally, in accordance with an illustrative embodiment. FIG. 13B depicts the effects of selective fouling on metasurfaces with increasing pitch in accordance with an illustrative embodiment.

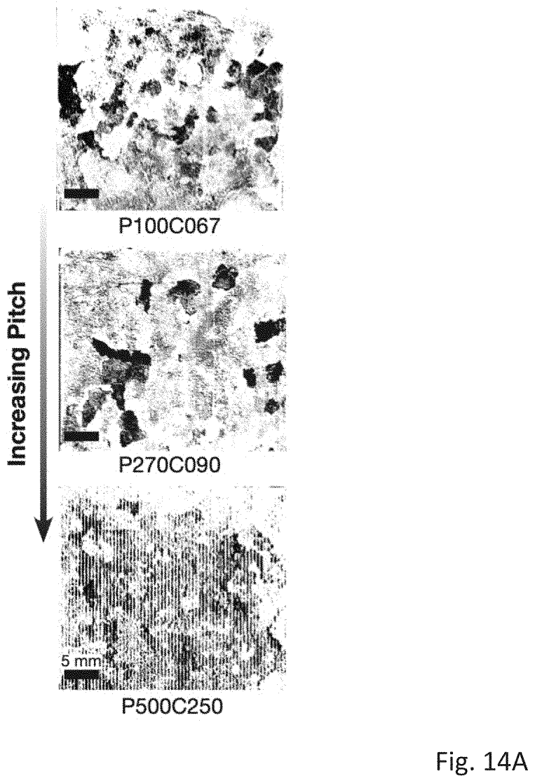

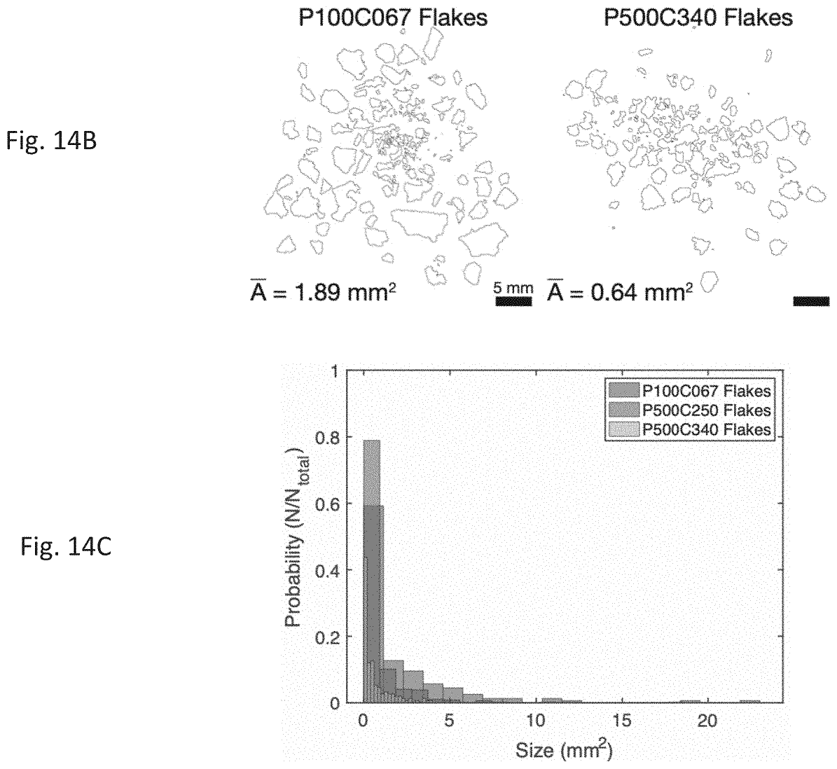

FIG. 14A depicts the differences in surface foulant accumulation that occurs on metasurfaces having increasing pitch in accordance with an illustrative embodiment. FIG. 14B shows flake patterns for different metasurfaces in accordance with an illustrative embodiment. FIG. 14C is a graph that shows probability vs size of flake formation for metasurfaces of varying design parameters in accordance with an illustrative embodiment.

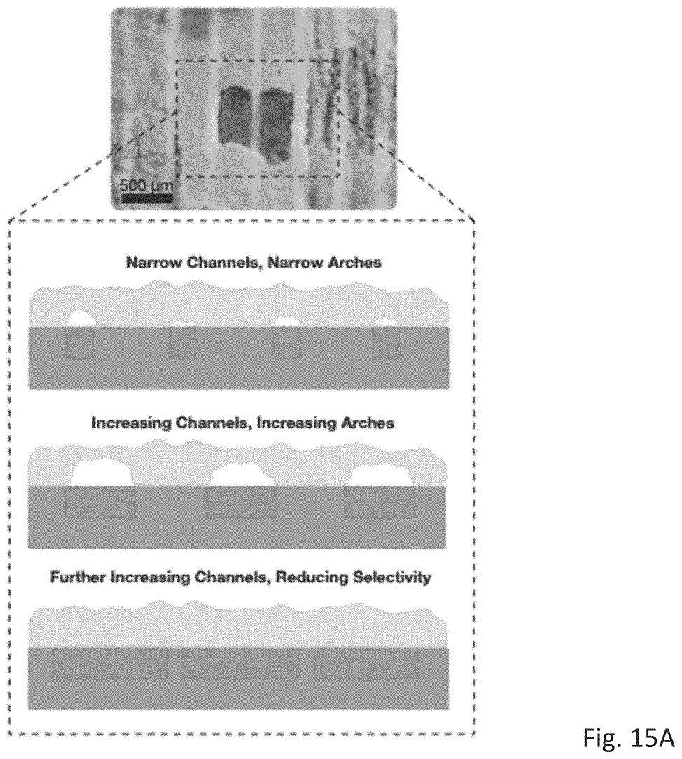

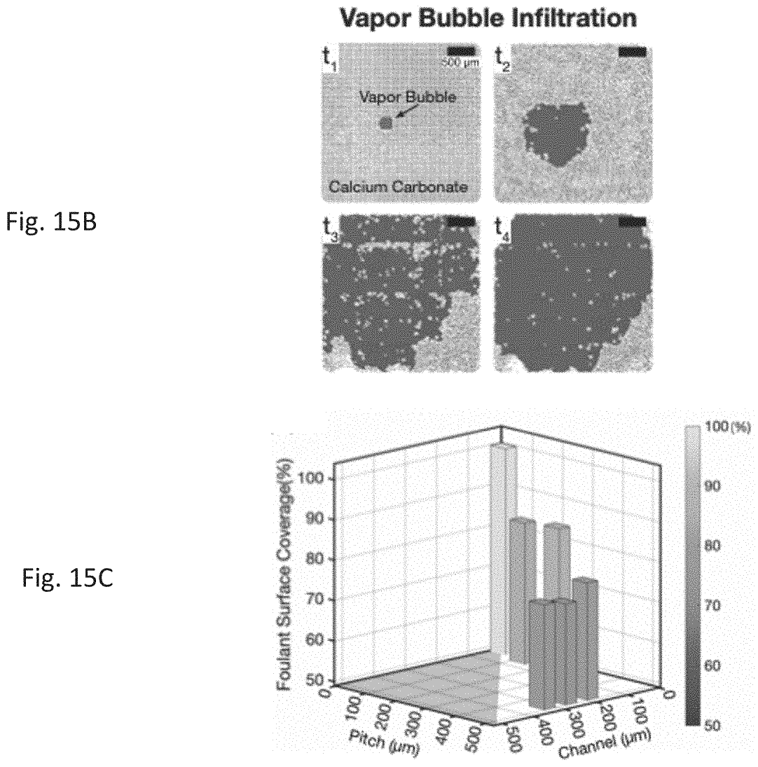

FIG. 15A depicts various channel characteristics and configurations in accordance with an illustrative embodiment. The configurations show how narrow channels result in narrow arches, increasing channels results in increased arches, and how further increasing the channel widths reduces selectivity. FIG. 15B depicts vapor bubble infiltration of a metasurface in accordance with an illustrative embodiment. FIG. 15C is a three-dimensional graph that shows foulant surface coverage vs pitch vs channel width, showing the optimal design parameters that result in maximized foulant flaking, in accordance with an illustrative embodiment.

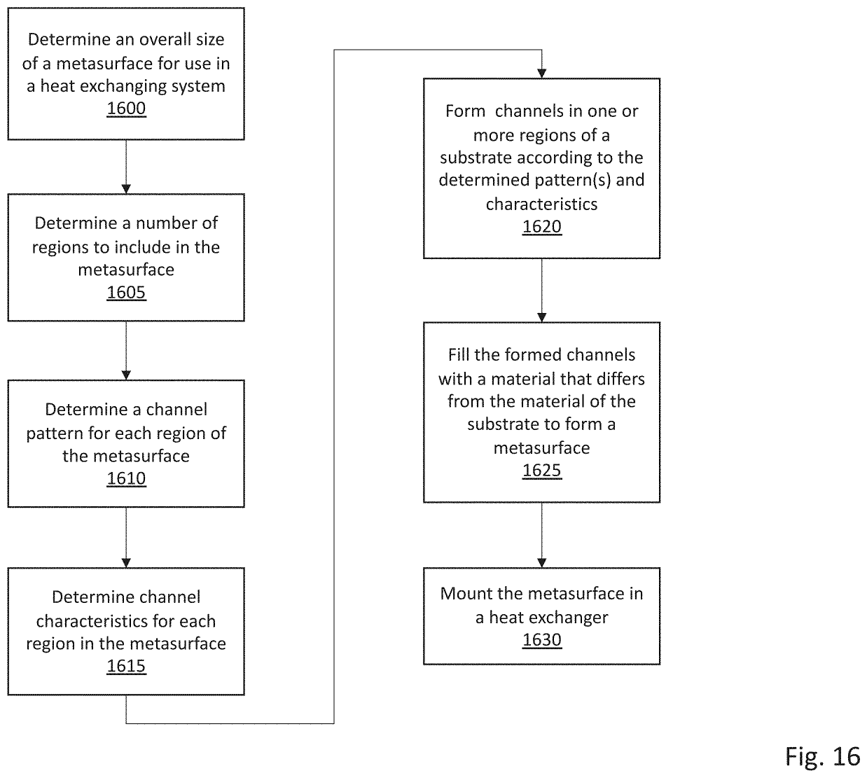

FIG. 16 is a flow diagram that depicts operations performed to form a metasurface in accordance with an illustrative embodiment. In alternative embodiments, fewer, additional, and/or different operations may be performed. Also, the use of a flow diagram is not meant to be limiting with respect to the order of operations performed. In an operation 1600, a determination is made regarding an overall size of a metasurface that is to be formed. In one embodiment, the determination can be made by a computing system that includes a processor, memory, transceiver, etc. The metasurface is for use in a heat exchanging system, and is intended to the surface upon which heat exchange is performed. The overall size can be in any size range, such as micrometers, millimeters, meters, etc. The size can be based on factors such as the desired size of the heat exchanging system.

In an operation 1605, a determination is made regarding a number of regions to include in the metasurface. In one embodiment, this operation can be performed by a computing system, as described above. As discussed herein, the metasurface can include a plurality of different regions, each of which has varying foulant build-up characteristics. For example, the metasurface may include one region, two regions, three regions, four regions, six regions, eight regions, sixteen regions, 32 regions, etc. The number of regions can be determined based on the overall size of the metasurface, along with any other factors such as available materials, desired antifouling properties, expected operating conditions, etc.

In an operation 1610, a channel pattern is determined for each region of the metasurface. The channel pattern can be determined by a computing device, or manually depending on the embodiment. The channel pattern can include a one-dimensional series of parallel channels that are spaced apart, a two-dimensional series of channels that intersect to form squares or rectangles, curved channels, etc. In one embodiment, each region of the metasurface can include a different channel pattern. In another embodiment, multiple regions of the metasurface can all have the same channel pattern, and in some embodiments all of the regions can include the same channel pattern.

In an operation 1615, channel characteristics are determined for each region in the metasurface. The channel characteristics can be determined by a computing device, or manually depending on the embodiment. The channel characteristics can include channel depth, channel length, channel width, the pitch between channels, channel profile (e.g., v-shaped, u-shaped, curved, 3-sided square shaped, etc.), etc. In one embodiment, each region can include channels all having the same characteristics. Alternatively, a given region can include channels having differing channel characteristics. Similarly, in some embodiments, different regions can have channels with differing characteristics. Alternatively, multiple regions can have channels that have the same characteristics.

In an operation 1620, the channels are formed in one or more regions of a substrate according to the determined patterns and characteristics. The substrate can be a piece of stainless steel in one embodiment. FIG. 1B depicts a stainless steel substrate in accordance with an illustrative embodiment. Alternatively, a different material may be used to form the substrate, depending on heat exchanger design considerations like thermal conductivity and cost. For example, other base materials can include iron, aluminum, copper, silicon, etc. The substrate can be in any shape (e.g., circle, square, rectangle, triangle, irregular, etc.) and thickness, depending on the type/size of the heat exchanger into which the substrate will be mounted. The channels can be formed using laser induced plasma micromachining, etching, cutting, or any other removal method known in the art. FIG. 1C depicts three channels formed in the substrate in accordance with an illustrative embodiment.

In an operation 1625, the formed channels are filled with a material that differs from the material of the substrate to form a metasurface. The fill material can be copper in one embodiment, although other materials can be used, according to the aforementioned design criteria such as thermal conductivity, thermal expansion, surface energy, and solid-solid adhesion. For example, other fill materials can include different metals from the base (like iron, aluminum, nickel, lead, etc.) or non-metals like polyethylene, silicon, carbon composites, etc. FIG. 1D depicts copper placed in the channels formed in the substrate in accordance with an illustrative embodiment. Alternatively, a different fill material may be used. Electroplating or any other application technique known in the art may be used to fill the channels. In an operation 1630, the metasurface is mounted into a heat exchanger for use to help reduce foulant buildup, as described herein. FIG. 2B depicts an illustrative metasurface having pitch of 100 micrometers and 270 micrometers in accordance with an illustrative embodiment. FIG. 2C depicts surface energies for a metasurface in accordance with an illustrative embodiment.

In an illustrative embodiment, the surfaces described herein can be used in phase change heating/cooling operations to prevent a foulant layer from building up. For example, the embodiments described herein can also be used in boiler-type heat exchangers, chemical processing applications, self-cleaning surface applications, corrosion resistant materials, heating, ventilation, and air conditioning (HVAC) systems, immersion cooling systems, data center and electronics cooling systems, power plant cooling systems, etc.

In summary, traditional liquid-side heat exchanger surfaces require frequent cleaning and water pretreatment. These cleaning and treating operations have significant costs, especially in industrial settings, due to a reduction in production capacity (i.e., steam, distillate, etc.). The proposed surfaces reduce foulant aggregation, resulting in higher overall time-averaged heat transfer, reduced equipment downtime, and a lesser requirement for extreme liquid pretreatment.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A method of forming a metasurface, the method comprising:
forming a plurality of unidirectional or multidirectional channels on a surface of a metallic, polymeric, or ceramic substrate formed from a first material;
filling the plurality of channels in the surface of the substrate with a second material that is different from the first material to form a metasurface on the substrate; and
placing the substrate into a heat exchange system such that the metasurface is proximate to a liquid used in the heat exchange system.

2. The method of claim 1, wherein forming the plurality of channels comprises forming a cross-grid pattern on the surface of the substrate.

3. The method of claim 1, where the first metal comprises steel and the second metal comprises copper.

4. The method of claim 1, wherein filling the plurality of channels comprises electroplating, 3D printing, or extruding the second material onto the surface of the substrate.

5. The method of claim 1, wherein the metasurface is designed to passively resist foulant aggregation as compared to a single material surface.

6. The method of claim 1, further comprising forming a plurality of regions in the metasurface, wherein each region has different channel curvatures, different channel thicknesses, or a different channel pattern.

7. The method of claim 6, further comprising forming a first region of the metasurface with a channel pattern of parallel lines, and forming a second region of the metasurface with a cross-grid channel pattern.

8. The method of claim 6, further comprising forming a first region with channels having a first depth, and forming a second region with channels having a second depth that differs from the first depth.

9. The method of claim 6, further comprising forming a first region with channels having a first width, and forming a second region with channels having a second width that differs from the first width.

10. The method of claim 6, further comprising forming a first region with channels having a first pitch, and forming a second region with channels having a second pitch that differs from the first pitch.

11. The method of claim 6, further comprising forming a first region with channels having a first cross-sectional profile, and forming a second region with channels having a second cross-sectional profile that differs from the first cross-sectional profile.

12. The method of claim 1, further comprising determining, based on a desired amount of fouled surface coverage over a period of time, one or more characteristics of the plurality of channels formed on the surface of the metallic sheet.

13. The method of claim 1, further comprising determining, based on a desired amount of fouled surface coverage over a period of time, a pattern of the plurality of channels formed on the surface of the substrate.

14. A metasurface for use in a heat exchange system, the metasurface comprising:
a substrate that is formed from a first material;
a plurality of channels formed on a surface of the substrate; and
a second material that is different from the first material, wherein the second material is within the channels formed in the substrate such that the metasurface passively resists foulant aggregation as compared to a single material surface.

15. The metasurface of claim 14, wherein the plurality of channels are formed as a cross-grid pattern on the surface of the substrate.

16. The metasurface of claim 14, where the first metal comprises steel and the second metal comprises copper.

17. The metasurface of claim 14, wherein the substrate is segmented into a plurality of regions, and wherein each region has different channel characteristics or a different channel pattern.

18. The metasurface of claim 17, wherein a first region of the metasurface has a channel pattern of parallel lines, and a second region of the metasurface has a cross-grid channel pattern.

19. The metasurface of claim 17, wherein a first region of the metasurface includes channels having a first depth, and a second region of the metasurface includes channels having a second depth that differs from the first depth.

20. The metasurface of claim 17, wherein a first region of the metasurface has channels of a first width, and a second region of the metasurface has channels of a second width that differs from the first width.
